(19) United States
(12) Patent Application Publication
(10) Pub. No.: US 2006/0061461 A1
(43) Pub. Date: Mar. 23, 2006

(54) Vehicle speed limit reminding device

(76) Inventor: Shih-Hsiung Li, Taipei (TW)

Correspondence Address: DELLETT & WALTERS, P. O. BOX 82788, PORTLAND, OR, 97282-0788, US

(21) Appl. No.: 10/945,628

(22) Filed: Sep. 20, 2004

(51) Int. Cl. B60Q 1/00; G06K 9/00; H04N 7/18; G08G 1/09; G08G 1/01

(52) U.S. Cl. 340/441; 340/905; 340/936; 382/104; 382/113; 348/148

(57) ABSTRACT

A vehicle speed limit reminding device includes an image receiving unit for receiving images from a speed limit sign, an image processing unit to process the image received by the image receiving unit, a microprocessor to receive a processed image signal from the image processing unit, a speedometer to send a speed signal to the microprocessor, a display to display the processed image signal processed by the image processing unit and an alarm operably connected to a second output of the microprocessor to send a warning signal for reminding a driver that current vehicle speed is over/lower than maximum/minimum speed limit such that the driver is able to grasp all speed information on the road from the display without distraction.

### BACKGROUND OF THE INVENTION

1. Field of the Invention

The present invention relates to a vehicle speed limit reminding device, and more particularly to the speed limit reminding device to receive an image of a speed limit sign on a road and compare with current vehicle speed after the speed limit image is digitized and processed by an image processing unit.

2. Description of Related Art

Based on safety concern, speed limit signs are mounted along highways to remind drivers that they can not drive too fast. Policemen patrolling the highways are there to force the drivers to follow the speed limit. However, some drivers neglect the basic driving safety rules and not only endanger themselves, but also others. To circumvent dangerous drivers, cameras and speed test guns are invented so that drivers afraid of receiving fines by the police are forced to follow the speed limit.

However, because the speed limit changes according to the local circumstances, drivers have to pay extra caution to the numeral changes in the speed limit signs. That is, the driver not only has to pay attention to the road conditions, but also has to pay attention to the speed limit changes to avoid breaking the law, which is quite exhausting for the drivers.

To overcome the shortcomings, the present invention tends to provide an improved speed limit reminding device to mitigate the aforementioned problems.

### SUMMARY OF THE INVENTION

The primary objective of the present invention is to provide an improved speed limit reminding device to constantly remind the driver if the current vehicle speed does not match the local speed limit.

In order to accomplish the objective, the speed limit reminding device has:
an image receiving unit to receive numeral images from the speed limit signs along the road;
an image processing unit operably connected to an output of the image receiving unit via a visual signal transforming interface to process the numeral image received by the image receiving unit;
a microprocessor operably connected to the image processing unit to receive a processed image signal from the image processing unit so as to compare with a current vehicle speed;
a speedometer operably connected to the input of the microprocessor to send a speed signal to the microprocessor such that the microprocessor is able to compare the current speed with the processed image signal processed by the image processing unit;
a display operably connected to a first output of the microprocessor to display the processed numeral image received by the image receiving unit; and
an alarm operably connected to a second output of the microprocessor to send an alarm to remind the driver that current driving speed is over/lower than maximum/minimum speed limit such that the driver is able to grasp all the speed information on the road from the display without distraction.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of the present invention;

FIG. 2 is a schematic view showing the possible location wherein the device is mounted on the vehicle;

FIG. 3 is a schematic view showing different possible location where the device of the present invention is mounted in the vehicle;

FIGS. 4A and B are real and virtual views taken and simulated by the image receiving unit;

FIGS. 5A and B are schematic views showing the division and comparison between the real and virtual views;

FIG. 6 is a schematic view showing the current speed limit sign; and

FIGS. 7A to 7C are schematic views showing the determination and judgement of the image processing unit to the numeral image.

### DETAILED DESCRIPTION OF THE PREFERRED EMBODIMENT

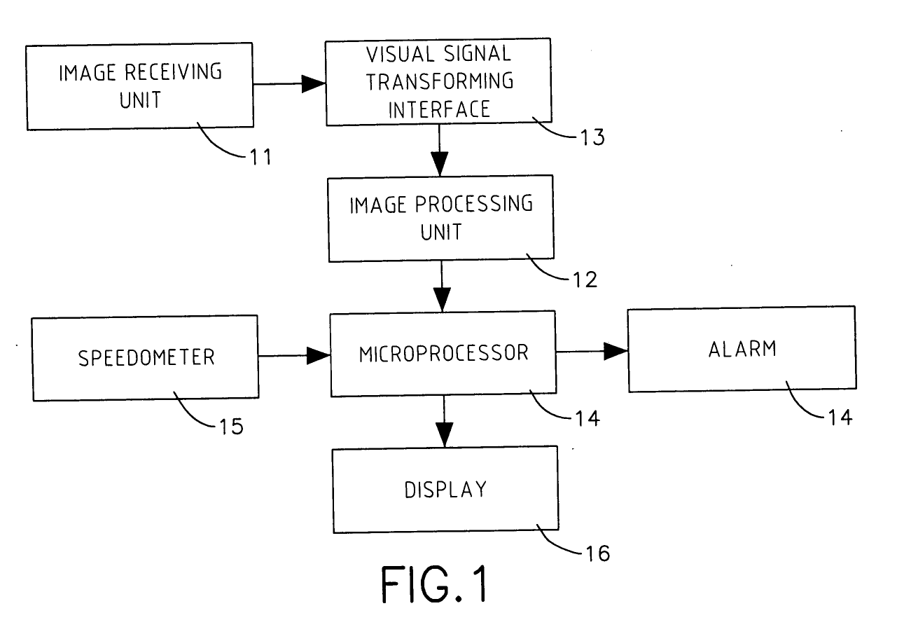

With reference to FIG. 1, the block diagram of the present invention shows that the vehicle speed limit reminding device includes an image receiving unit (11) to receive numeral images from the speed limit signs along the road, an image processing unit (12) operably connected to an output of the image receiving unit (11) via a visual signal transforming interface (13) to process the numeral image received by the image receiving unit (11), a microprocessor (14) operably connected to the image processing unit (12) to receive a processed image signal from the image processing unit (12) so as to compare with a current vehicle speed, a speedometer (15) operably connected to the input of the microprocessor (14) to send a speed signal to the microprocessor (14) such that the microprocessor (14) is able to compare the current speed with the processed image signal received by the image receiving unit (11) and processed by the image processing unit (12), a display (16) operably connected to a first output of the microprocessor (14) to display the processed numeral image received by the image receiving unit (11) and an alarm (17) operably connected to a second output of the microprocessor (14) to send an alarm to remind the driver that current driving speed is over/lower than the maximum/minimum speed limit such that the driver is able to grasp all the speed information on the road from the display without distraction. It is noted that the alarm may be a visual warning signal, such as a red light indicator or an acoustic warning signal. The frequency of light flashing in different frequencies may also be used as an index for reference by the driver to show the degree of exceeding the maximum/minimum speed limit.

The image processing unit (12) is a high speed digital processor to proceed mass operation to the digital signal from the visual signal transforming interface (13) so as to identify useful characters and numerals. Furthermore, the image processing unit (12) has the following advantages:
(1). Filtering the dynamic images received by the image receiving unit (11) and enhancing the images to avoid interference and increase identification;
(2). Automatically searching for speed limit sign;
(3). Automatically adopting characters from the speed limit sign;
(4). Identifying the characters; and
(5). Sending the identified characters to the microprocessor (14) for further processing.

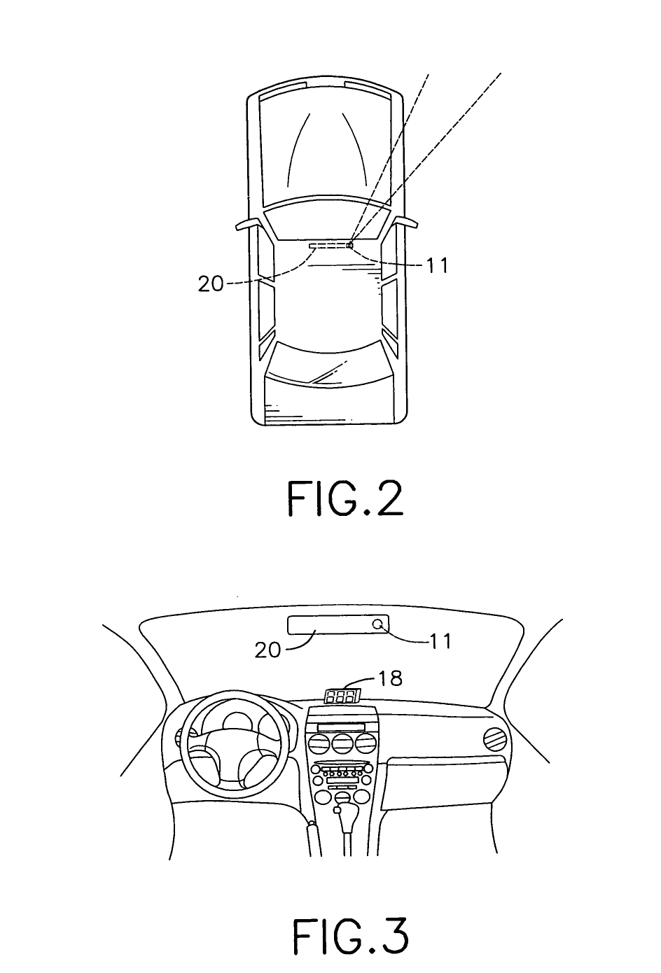

The possible locations for mounting the image receiving unit (11), the display (16) and the alarm (17) are shown in FIGS. 2 and 3, wherein the image receiving unit (11) is mounted on the rear view mirror (20) the object perception angle of which is based on local traffic rules. For example, in Asian areas, vehicles are limited to the right of the road so that the rear view mirror is angled to the front right to receive continual images coming from the front right of the road. The image receiving unit (11) may be located on a side of the panel to combine with the display (16) and the alarm (17).

In this embodiment, the display (16) and the alarm (17) are incorporated together as a display-warning device (18) and mounted on top of the panel to facilitate observation by the driver.

The principle of the device of the present invention is as follows:

Taking the freeway for example, the image receiving unit (11) receives continuous images such as the road shoulder. As a consequence of image continuity, the image processing unit (12) is able to simulate the image ahead of the vehicle in the near future based on the current and local image. Therefore, if there is no speed limit sign in the received images, the simulated images by the image processing unit (12) match with the real images taken by the image receiving unit (11). The interrelationship between the simulated images and the real images matches the Gauss distribution.

However, if there is an additional object appearing in the real images, differences occur in the simulated and real images.

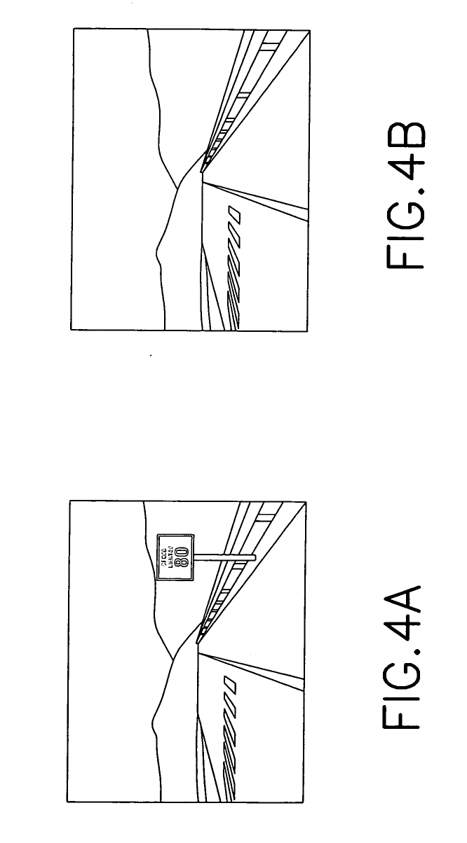

With reference to FIGS. 4A and 4B, it is to be noted that the view in FIG. 4A is a real image taken by the image receiving unit (11) and the view in FIG. 4B is a simulated image by the image processing unit (12). Therefore, except for the speed limit sign, the remainder of elements in the two images are well within an allowable tolerance.

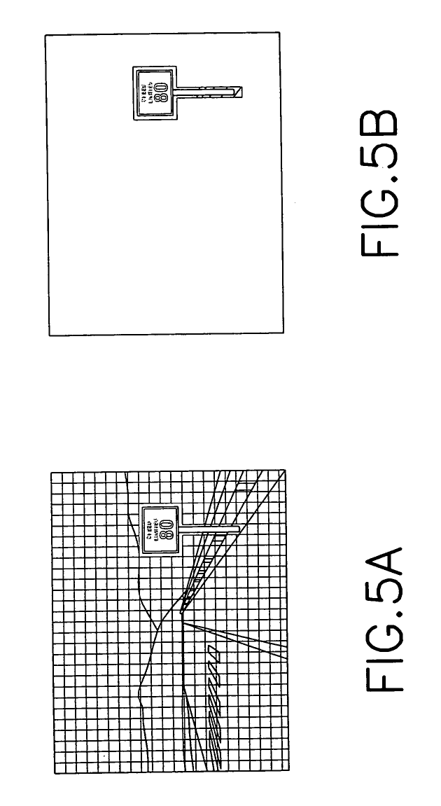

When a difference occurs between the simulated image and the real image, the image processing unit (12) divides the real image and the simulated image into squares and then compares each square in the real image with a corresponding one of the squares in the simulated image, as shown in FIGS. 5A and 5B, wherein the difference, the speed limit sign, is thus presented in the image processing unit (12).

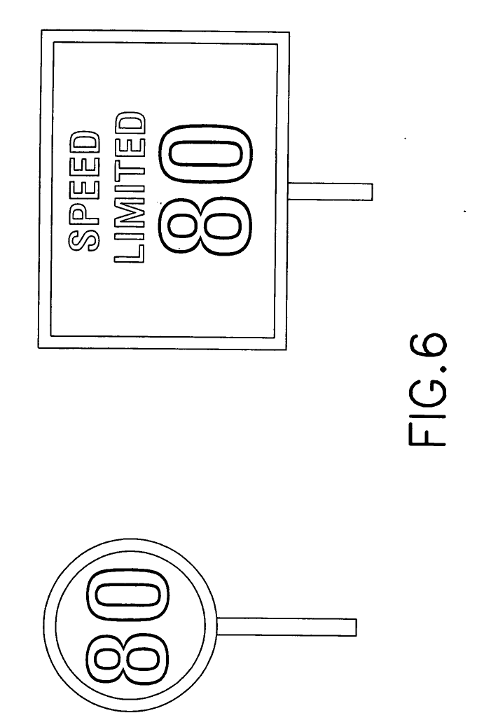

In general, the characters and numerals on the speed limit sign are brighter than the surroundings such that the horizontal gradient of the speed limit sign is more obvious than the vertical gradient. Furthermore, as shown in FIG. 6, the speed limit sign has a regulated shape and appearance such that the image processing unit (12) is able to process the gradient information of the speed limit sign and enhance, filter out non-numeral information on the speed limit sign.

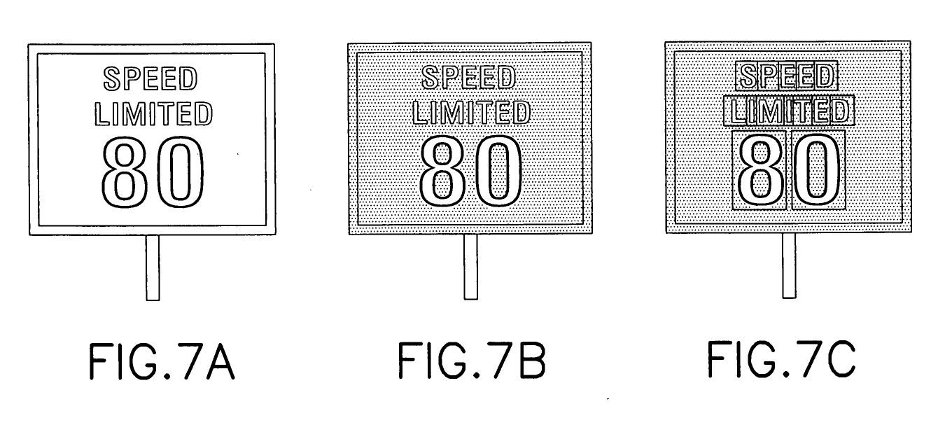

With reference to FIGS. 7A to 7C, the image shown in FIG. 7A is the real image, the image in FIG. 7B is the binary image and the image in FIG. 7C is the chosen image. The image processing unit (12) is able to process the real image and indicate the real image in a binary image. Small areas in the binary image are combined to form one or several rectangles. The image processing unit (12) is able to delete rectangles containing no speed limit information so as to acquire candidate speed limit information.

Thereafter, the image processing unit (12) divides the candidate speed limit information by projection to acquire characters in the speed limit sign. First the characters in the speed limit sign are located and positioned and then the image processing unit (12) acquires the character rectangles individually by statistics as shown in FIG. 7C.

Because the characters on the speed limit sign are limited, the image processing unit (12) is able to establish a vector with a length of N for each possible character on the speed limit sign, where N is the amount of pixels to form the character. Vectors for the characters to be identified by the image processing unit (12) are established and each have a length of N. Then comparison between the characters to be identified and the possible characters in the image processing unit (12) is made to select the most possible character(s).

Confusing characters such as 8 and B or 0 and O may be processed further by the image processing unit (12).

After the image processing unit (12) acquires the current speed limit information from the speed limit sign, the microprocessor (14) is informed to record the allowable maximum speed. The microprocessor (14) continuously checks and compares the current speed with the allowable maximum speed. If the current speed is lower than what is allowed, the display (16) only shows the current speed and the alarm (17) does not generate a warning signal. If the current speed exceeds the allowable maximum speed limit, the microprocessor (14) sends a signal to the alarm (17) to start a warning signal in different frequencies according to the degree of exceeding the speed limit. The driver is able to set the alarm in different frequencies based on the exceeding degree of the allowable maximum speed limit. For example, the first frequency may be set when the current speed exceeds the first range, e.g. 5 Km and the second frequency may be set when the current speed exceeds the second range, e.g. −10 Km. Therefore, when the alarm (17) signals in the first frequency and the allowable maximum speed limit is 120 Km, the current speed is 125 Km and when the alarm (17) goes off in the second frequency and the allowable maximum speed limit is 120 Km, the current speed is 110 Km.

According to the foregoing description, the driver is able to focus on the traffic conditions without any distraction to the speed limit signs such that not only the driver's safety is ensured, the driver is able to avoid receiving any speeding ticket.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A vehicle speed limit reminding device comprising:
an image receiving unit for receiving images from a speed limit sign along a road;
an image processing unit operably connected to an output of the image receiving unit via a visual signal transforming interface to process the image received by the image receiving unit;
a microprocessor operably connected to the image processing unit to receive a processed image signal from the image processing unit so as to compare with a current vehicle speed;
a speedometer operably connected to the input of the microprocessor to send a speed signal to the microprocessor such that the microprocessor is able to compare the current speed with the processed image signal processed by the image processing unit;
a display operably connected to a first output of the microprocessor to display the processed image signal processed by the image processing unit; and
an alarm operably connected to a second output of the microprocessor to send a warning signal for reminding a driver that current vehicle speed is over/lower than maximum/minimum speed limit such that the driver is able to grasp all speed information on the road from the display without distraction.

2. The device as claimed in claim 1, wherein the image processing unit is a high speed digital processor.

3. The device as claimed in claim 1, wherein the warning signal from the alarm is divided into a visual signal, an acoustic signal or a combination thereof.

4. The device as claimed in claim 3, wherein the warning signal is set to have different frequencies.

5. The device as claimed in claim 3, wherein the image receiving unit is adapted for mounting on a rear view mirror inside a vehicle.

6. The device as claimed in claim 4, wherein the image receiving unit is adapted for mounting on a rear view mirror inside a vehicle.

7. The device as claimed in claim 1, wherein the alarm is integrally formed with the display.

8. The device as claimed in claim 6, wherein the alarm is integrally formed with the display.
